(19) United States
(12) Patent Application Publication
(10) Pub. No.: US 2025/0128580 A1
(43) Pub. Date: Apr. 24, 2025

(54) ASSEMBLIES FOR MOVING A COVER, AND VEHICLE ROOF

(71) Applicant: Webasto SE, Stockdorf (DE)

(72) Inventors: Sebastian GERING, Stockdorf (DE); Andrei POPOVICI, Stockdorf (DE)

(21) Appl. No.: 18/834,907

(22) PCT Filed: Feb. 10, 2023
(86) PCT No.: PCT/EP2023/053311

§ 371 Date: Jul. 31, 2024

(30) Foreign Application Priority Data
Feb. 14, 2022 (EP) 22156543.5

(51) Int. Cl. B60J 7/053; B60J 7/043; B60J 7/057; E05D 15/10; E05F 15/643; E05F 15/655

(52) U.S. Cl. CPC B60J 7/053; B60J 7/043; B60J 7/0573; E05D 15/1021; E05D 15/1081; E05F 15/643; E05F 15/655; E05Y 2201/626; E05Y 2900/542

(57) ABSTRACT

Assemblies for moving a cover for a vehicle roof are described, having, for example a guide rail which is elongated along a longitudinal direction, a carriage which can be moved along the longitudinal direction in the guide rail and which comprises a slotted deployment guide for a deployment lever, the slotted deployment guide having a sliding path which has a first portion and a second portion along the longitudinal direction, wherein the slotted deployment guide has a first extent in the first portion along a transverse direction, which extends transversely to the longitudinal direction, and the slotted deployment guide has a second extent, which is greater than the first extent, in the second portion along the transverse direction.

### CROSS-REFERENCE TO RELATED APPLICATIONS

This application is a U.S. national phase application filed under 35 U.S.C. § 371 of International Application No. PCT/EP2023/053311, filed on Feb. 10, 2023, published under WO 2023/152296 A1 on Aug. 17, 2023, designating the United States, which claims priority from EP application Number 22156543.5, filed on Feb. 14, 2022, which are hereby incorporated herein by reference in their entirety.

### FIELD

Assemblies for moving a cover for a vehicle roof are described. In addition, a vehicle roof is described which in particular has at least one such assembly.

### BACKGROUND

Such assemblies for a vehicle roof are used, for example, to lift a cover, starting from a closed position for closing a roof opening, first in its rear area for opening by means of a deployment mechanism and then to move it backwards into an open position. DE 10023314 C1, for example, describes a so-called externally guided sliding roof.

### SUMMARY

It is desirable to specify assemblies for moving a cover for a vehicle roof that allow reliable operation.

According to a first aspect, an assembly for moving a cover for a vehicle roof according to embodiments has a guide rail which is elongated along a longitudinal direction. The assembly has a carriage which can be moved along the longitudinal direction in the guide rail. The carriage has a slotted deployment guide for a deployment lever. The slotted deployment guide has a sliding path. The sliding path has a first portion and a second portion along the longitudinal direction. In the first portion, the slotted deployment guide has a first extent along a transverse direction. The transverse direction runs transversely to the longitudinal direction, for example perpendicular to the longitudinal direction in the horizontal plane. In the second portion, the slotted deployment guide has a second extent along the transverse direction. The second extent is greater than the first extent.

The carriage therefore has a slotted deployment guide that is of different widths along the transverse direction. For example, a higher support force for the deployment lever is possible in the wider second portion during operation. Using the second portion, higher forces can be taken up by the carriage during operation and transferred to the guide rail. In the narrower first portion, fewer forces have to be taken up by the carriage and transferred to the guide rail. This means that less installation space is required for the slotted deployment guide and the sliding path, particularly in the first portion, for example along the transverse direction.

According to at least one further embodiment, the slotted deployment guide has a course along the longitudinal direction, so that the slotted deployment guide first rises along the longitudinal direction, then runs in a straight line and then falls. The first portion and the second portion adjoin each other in the straight region of the course. This means that a sufficiently long, wider second portion can be realized and sufficient installation space can be saved in the first portion.

According to at least one further embodiment, the carriage has a slotted control guide for a control rod. The slotted control guide and the slotted deployment guide are arranged along the transverse direction on opposite sides of the carriage. In particular, the slotted control guide is formed in an area corresponding to the first portion. The slotted deployment guide, which is narrower in the first portion, allows the slotted control guide to be arranged opposite the slotted deployment guide on the carriage without requiring a lot of additional installation space. The slotted control guide and the slotted deployment guide do not have to be offset from each other, particularly along a vertical upward direction. In projection, the slotted control guide and the slotted deployment guide overlap at least partially.

According to at least one further embodiment, the slotted control guide and the first portion of the slotted deployment guide are arranged next to each other along the transverse direction. A partition wall of the carriage is arranged between the slotted control guide and the slotted deployment guide along the transverse direction. The partition wall enables a stable design of the carriage even in the area in which the slotted control guide and the slotted deployment guide are arranged.

According to at least one further embodiment, the carriage has a carriage slider. The carriage slider is guided in the guide rail. The carriage slider and the slotted deployment guide are offset from each other along the longitudinal direction. This enables a lever slider of the deployment lever to be arranged along the longitudinal direction behind the carriage slider and along the vertical direction at the same height as the carriage slider, particularly when the cover is open. This increases the stability of the assembly and, in particular, the assembly is robust so that it is stable enough even in the event of accidents.

According to a second aspect, an assembly for moving a cover for a vehicle roof according to a further embodiment has a guide rail which is elongated along a longitudinal direction. The guide rail has a guide path. The guide path is designed for a carriage slider of a carriage and for a control slider of a control rod. The guide path has a first portion and a second portion along the longitudinal direction. The guide rail has a slotted locking guide for the control rod. The slotted locking guide is arranged at a transition between the first portion and the second portion. The slotted locking guide has a recess. The recess is dimensioned in such a way that the carriage slider can be guided through the recess. The recess is dimensioned in such a way that the control slider by means of the slotted locking guide can be inserted into the guide path and can be deflected out of the guide path.

The guide path and the slotted locking guide with the recess are dimensioned in such a way that the control slider cannot pass through the recess. This means that the slotted locking guide with the recess forms a kind of switch at the transition. The recess is large enough to allow the carriage slider to pass through the recess and thus not leave the guide path of the guide rail at the transition at the slotted locking guide. During operation, the carriage slider passes through the recess without being deflected by the slotted locking guide.

The recess is small enough so that the control slider cannot be guided through the recess. At the transition, the control slider is guided over the recess and thus deflected by the slotted locking guide. The slotted locking guide has a portion next to the recess where the control slider can slide along the slotted locking guide next to the recess. The slotted locking guide thus enables the control slider to be guided out of the guide path, particularly along the vertical upward direction, and to be inserted into the guide path along the vertical direction. In particular, if the control slider is arranged in the slotted locking guide above the recess, it is possible for the carriage slider to be moved through the recess relative to the control slider.

According to at least one further embodiment, the slotted locking guide extends away from the guide path at an angle to the longitudinal direction. The slotted locking guide thus enables the control slider to be locked along the longitudinal direction when the control slider is arranged in the slotted locking guide. By inserting the control slider from the slotted locking guide into the guide path, it is possible to move the control slider along the longitudinal direction relative to the guide rail.

According to at least one further embodiment, the first portion is provided to guide the carriage slider. The second portion is provided to guide the carriage slider and the control slider. In particular, the second portion is designed so that both the carriage slider and the control slider can be guided together in the guide path one behind the other in the longitudinal direction. In the first portion, only the carriage slider is guided during operation and, in particular, the control slider does not reach the first portion during intended use.

According to at least one further embodiment, the guide path has a first extent in the first portion along a transverse direction. The guide path has a second extent in the second portion along the transverse direction. The second extent is greater than the first extent. The first extent corresponds to a transverse extent of the recess. In the second portion, the guide path has the second extent, which is wide enough for both the carriage slider and the control slider to be guided and reliably supported. The second extent only has to guide and support the carriage slider, so that the smaller width is sufficient for this. The guide rail as a whole can have the same width along the transverse direction in the first portion and in the second portion. However, the guide path, which is in contact with sliders, is narrower in the first portion, as the carriage slider in particular is narrower than the control slider.

According to a further embodiment, the slotted locking guide has a transverse extent, at least in portions, which corresponds to the second extent. The slotted locking guide is as wide or substantially as wide as the guide path in the second portion. This makes it possible for the control slider to be reliably guided in the slotted locking guide.

According to a fourth aspect, an assembly for moving a cover for a vehicle roof according to one embodiment has a front deployment lever and a rear deployment lever. The assembly has a carriage. The rear deployment lever is engaged with the carriage. The assembly has a control rod. The control rod is used to couple the front deployment lever to the carriage. The control rod has a protrusion for engagement in a slotted control guide of the carriage.

Coupling the front deployment lever with the rear deployment lever by means of the control rod improves the natural frequency and thus increases robustness. This means, for example, that covers with greater weights can be used. The slotted control guide for moving the control rod is arranged in the carriage. This means that less installation space is required compared to an assembly in which the slotted control guide is arranged in a guide rail.

According to at least one further embodiment, the control rod has a control slider. The control slider is designed to engage in a guide rail. The control slider and the protrusion are arranged at a first end of the control rod. The control slider and the protrusion are arranged facing away from each other. In this way, the control rod can be guided in the slotted control guide of the carriage with minimal installation space requirements, and the control slider can be used to guide and optionally lock the control rod in the guide rail.

According to a fourth aspect, an assembly for moving a cover for a vehicle roof according to one embodiment has a deployment lever. The deployment lever has an elongated lever body. The deployment lever has a gripper projecting transversely from the lever body. The gripper is designed to grip around a carriage. The gripper is designed so that the lever body and the gripper can be arranged on opposite sides of the carriage. This makes it possible to support the deployment lever along the transverse direction on the two opposite sides of the carriage. This means that the deployment lever can be supported reliably and in a stable manner.

According to at least one further embodiment, the deployment lever has a first and a second lever slider. Each of the two lever sliders can be guided in a slotted deployment guide. The first lever slider has a smaller extent along a transverse direction than the second lever slider. Forces occurring during operation are primarily transferred to the carriage by means of the second lever slider. This means that the first lever slider, on which lower forces occur, can be made narrower. This enables sufficiently stable and robust support of the deployment lever despite requiring less installation space.

According to one embodiment, a vehicle roof has at least one assembly according to the first aspect, according to the second aspect, according to the third aspect or according to the fourth aspect. Different embodiments of the individual assemblies can be combined with one another as desired. According to embodiments, the vehicle roof has two assemblies according to the various aspects, three assemblies or four assemblies. The assemblies work together to enable a robust vehicle roof in which the deployment mechanism requires little installation space.

According to embodiments, the assemblies are part of an externally guided sliding roof, in which the rear deployment lever on the rear edge of the cover is moved together with the cover relative to the rest of the vehicle roof in the opening direction.

Further advantages, features and developments can be found in the following examples, which are explained in conjunction with the figures. Elements that are identical, similar and have the same effect can be provided with the same reference signs across all figures.

### BRIEF DESCRIPTIONS OF THE DRAWINGS

In the figures:

FIG. 1 is a schematic representation of a vehicle according to an exemplary embodiment,

FIGS. 2 and 3 show a schematic representation of a deployment mechanism according to an exemplary embodiment,

FIGS. 4 to 17 show schematic representations of various detailed views of the deployment mechanism according to exemplary embodiments.

### DETAILED DESCRIPTION

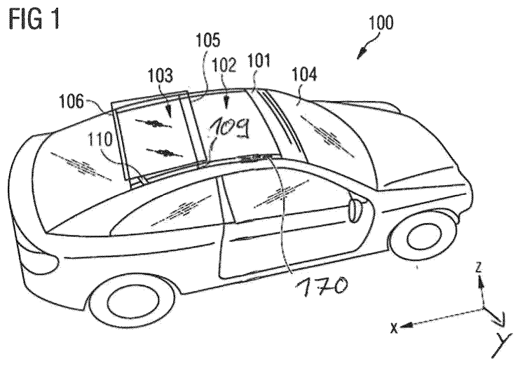

FIG. 1 shows a vehicle 100 according to an exemplary embodiment. The vehicle 100 has a vehicle roof 101. A cover 103 is arranged on the vehicle roof 101. The cover 103 is, for example, movable relative to the rest of the vehicle roof 101. Thus, a roof opening 102 can optionally be closed or partially opened by the cover 103.

The vehicle has a windshield 104. The cover 103 has a front edge 105, which faces the windshield 104 in the operational state. A rear edge 106 of the cover 103 faces away from the windshield 104 along a longitudinal direction X.

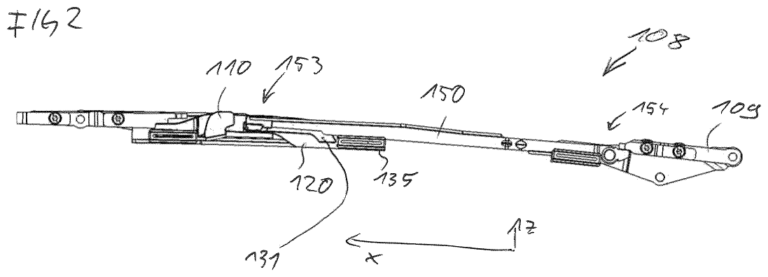

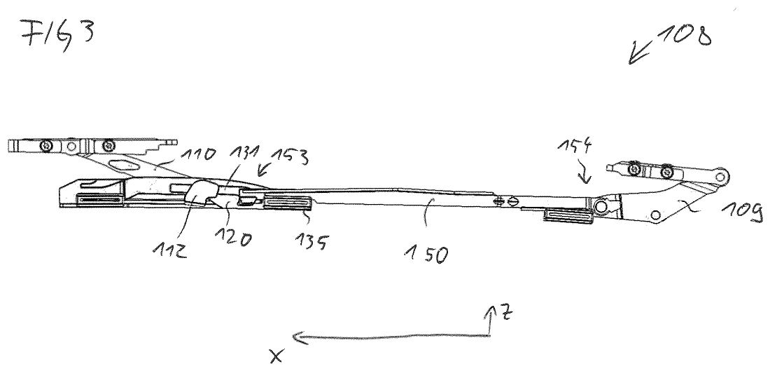

The movement of the cover 103 is realized with a deployment mechanism 108 (FIGS. 2 and 3). The deployment mechanism 108 has, for example, a guide rail 170, which is connected to the vehicle roof 101. A drive cable, for example, is guided in the guide rail 170. The drive cable is, for example, in contact with an electric drive motor and other components of the deployment mechanism 108 in order to move the cover 103 relative to the rest of the vehicle roof 101.

For example, the deployment mechanism 108 is embodied in the manner of a so-called externally guided sliding roof. A rear deployment lever 110, which is associated with the rear edge 106, is moved in the opening direction together with the cover 103 relative to the rest of the vehicle roof during operation. This can be different, for example, in the case of so-called spoiler roofs, in which the cover is moved relative to the rear deployment lever for opening.

Location-based or direction-based specifications used, such as rear or front, top or bottom, left or right, vertical or horizontal, refer to a longitudinal axis of the vehicle and a usual direction of travel of an operational vehicle 100. The longitudinal vehicle axis can also be referred to as a horizontal axis or X-axis in the associated longitudinal axis X. The vehicle transverse axis can also be referred to as a horizontal axis or Y-axis in the associated transverse direction Y. The vehicle vertical axis can also be referred to as a vertical axis or Z-axis in the associated vertical direction Z. The vertical direction, the transverse direction and the longitudinal direction are in particular oriented perpendicular to each other.

In particular, the deployment mechanism 108 is arranged on both sides of the roof opening 102 and is designed in the same way in each case. Therefore, only one side is described below and the description, features and advantages also apply correspondingly to the opposite side.

FIGS. 2 and 3 show the deployment mechanism 108 according to an exemplary embodiment. FIG. 2 shows the deployment mechanism 108 in a closed position of the cover 103. FIG. 3 shows the deployment mechanism 108 in an open position of the cover 103.

The deployment mechanism 108 has a front deployment lever 109. In operation, the front deployment lever 109 is arranged at the front edge 105 of the cover 103. In operation, the rear deployment lever 110 is arranged at the rear edge 106 of the cover 103. By means of the rear deployment lever 110, the rear edge 106 can be raised and lowered along the vertical direction Z. The front edge 105 of the cover 103 can be raised and lowered by means of the front deployment lever 109. In addition, the cover 103 can be moved along the longitudinal direction X by means of the two deployment levers 109 and 110.

The front deployment lever 109 is coupled to the rear deployment lever 110 by means of a control rod 150.

The control rod 150 is elongated along the X-direction. At a front end 154, the control rod is connected to the front deployment lever 109, so that rotation of the front deployment lever 109 relative to the control rod 150 is possible.

At a rear end 153, the control rod 150 is connected to a carriage 120. The carriage 120 is in turn connected to the rear deployment lever 110. Thus, the rear deployment lever 110 and the control rod 150 are indirectly connected to each other by means of the carriage 120.

The carriage 120 is held and guided in the guide rail 170. The carriage 120 is displaceable relative to the guide rail 170 along the longitudinal direction X in order to drive the movement of the cover 103. In particular, the carriage 120 is arranged at the rear edge 106 of the cover 103 or in a rear region of the cover 103.

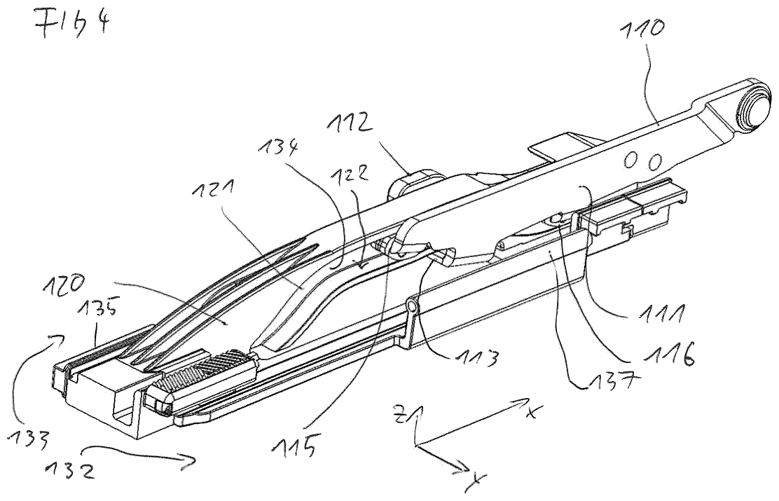

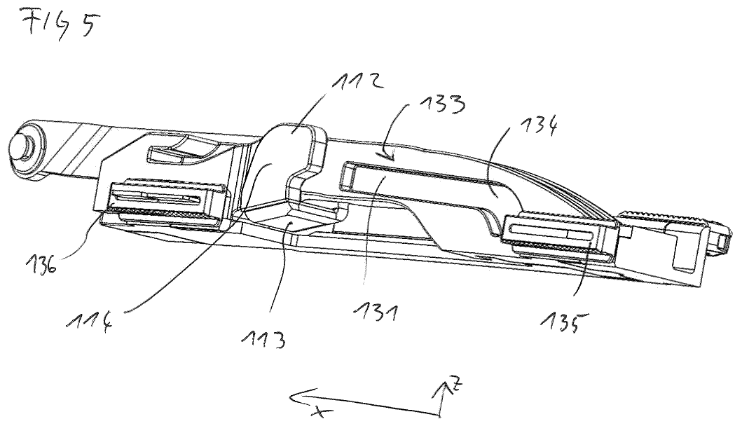

FIGS. 4 and 5 show the carriage 120 and the rear deployment lever 110 according to an exemplary embodiment.

The carriage 120 has a longer extent along the longitudinal direction X than along the transverse direction Y and the vertical direction Z. The carriage 120 is guided in the guide rail by means of carriage sliders 135, 136. For example, the carriage slider 135 is arranged at a front end of the carriage 120 and the carriage slider 136 is arranged at a rear end of the carriage 120.

The carriage 120 has a slotted control guide 131. The slotted control guide 131 is used to couple the carriage 120 to the control rod 150.

The carriage 120 has a slotted deployment guide 121. The slotted deployment guide 121 is used to couple the carriage 120 to the rear deployment lever 110.

The slotted deployment guide 121 is arranged on a first side 132 of the carriage. The slotted control guide 131 is arranged on an opposite second side 133 of the carriage. The two sides 132, 133 are arranged opposite one another along the transverse direction X and extend substantially in XZ planes.

The carriage 120 is thus designed to engage with the deployment lever 110 on one side 132 and with the control rod 150 on the opposite side 133.

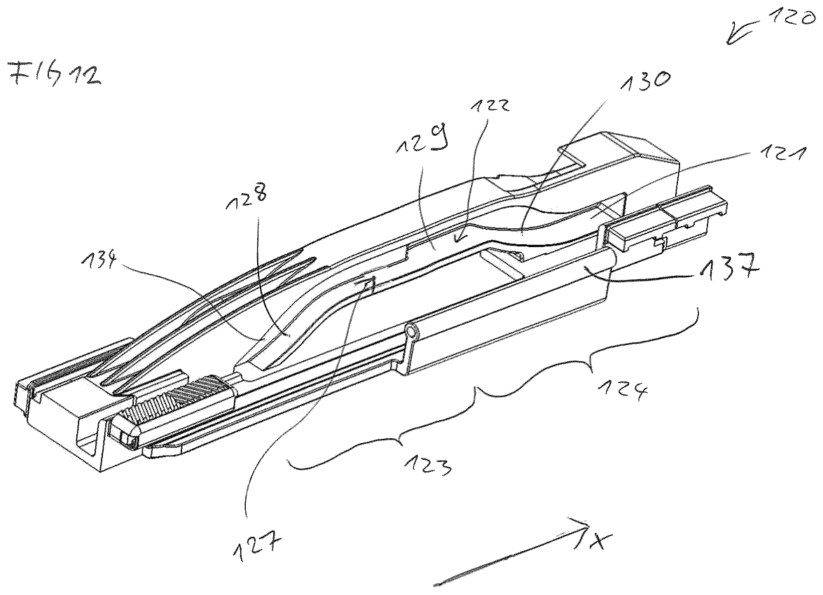

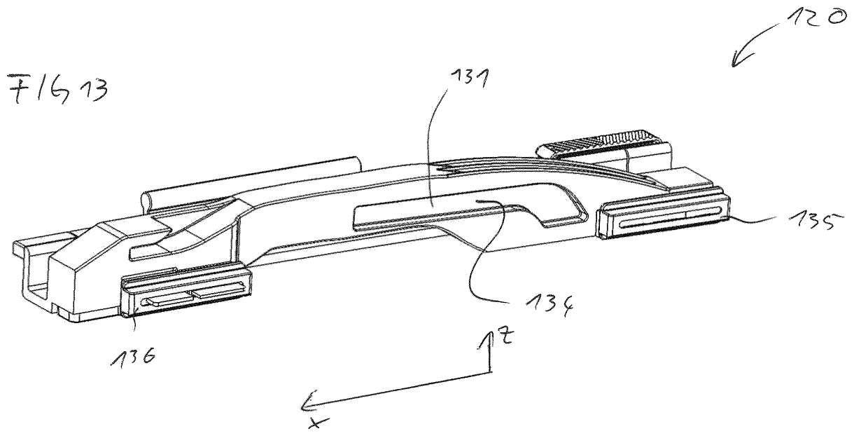

By displacing the carriage 120 relative to the guide rail 170, it is thus possible to cause a movement of the rear deployment lever 110. A movement of the control rod 150 can thus be caused by displacing the carriage 120. As can also be seen from FIGS. 12 and 13, the carriage 120 has a cable connection 137. By means of the cable connection 137, the carriage 120 is connected to a drive cable, so that a drive force of an electric motor can be transmitted to the carriage 120.

The slotted deployment guide 121 runs along the X direction at different levels along the vertical direction Z. The slotted deployment guide 121 has a first region 128 along the longitudinal direction X from front to rear, which runs obliquely upwards. The slotted deployment guide 121 has a second region 129 which adjoins the first region 128. The second region 129 runs substantially in a straight line, without rising or falling along the vertical direction Z. The slotted deployment guide 121 has a third region 130, which adjoins the second region 129 along the longitudinal direction X. The third region 130 is designed to slope downwards, so that the third region 130 is designed with a downward incline along the vertical direction Z. The slotted deployment guide 121 thus has a course 127 which is initially inclined along the longitudinal direction X, then runs in a straight line without inclination and is then inclined again.

The slotted deployment guide 121 has a sliding path 122. The sliding path is in particular the lower boundary wall of the slotted deployment guide 121 along the vertical direction X. Lever sliders 115, 116 of the rear deployment lever 110 can be supported on the sliding path 122. Forces of the cover 103 are thus transmitted by means of the rear deployment lever 110 to the carriage 120 and thus to the guide rail 170.

The slotted deployment guide 121 and the sliding path 122 have a first portion 123 and a second portion 124. In particular, the first portion 123 is formed along the longitudinal direction X in a front region of the slotted deployment guide 121. In particular, the second portion 124 is formed along the longitudinal direction X in a rear region of the slotted deployment guide 121. Along the longitudinal direction X, the first portion 123 ends in the rectilinear second region 129. Along the longitudinal direction X, the second portion 124 begins in the rectilinear second region 129. In particular, the first portion 123 and the second portion 124 are directly adjacent to each other in the second region 129.

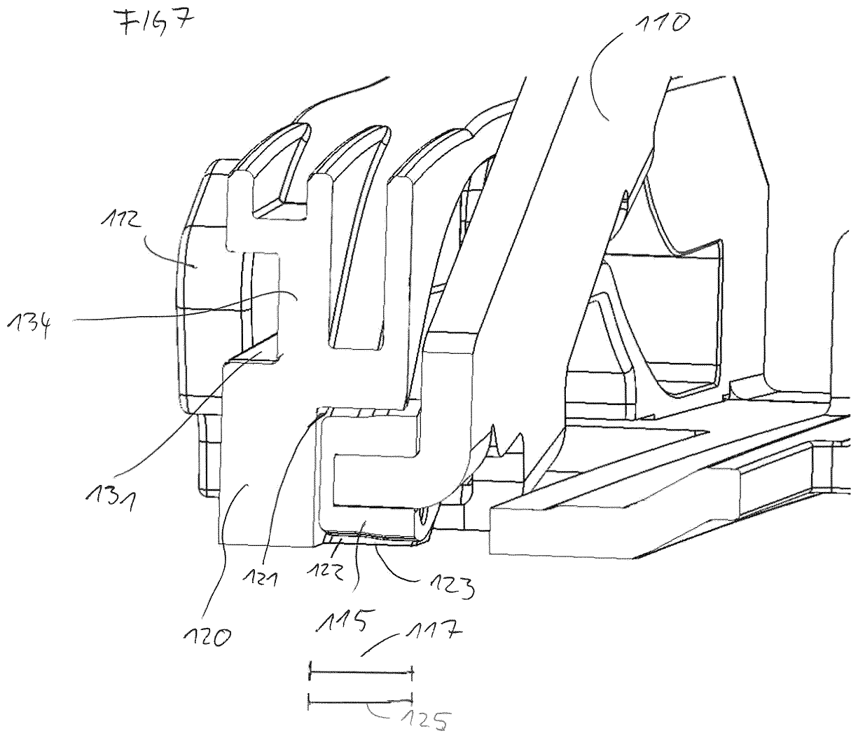

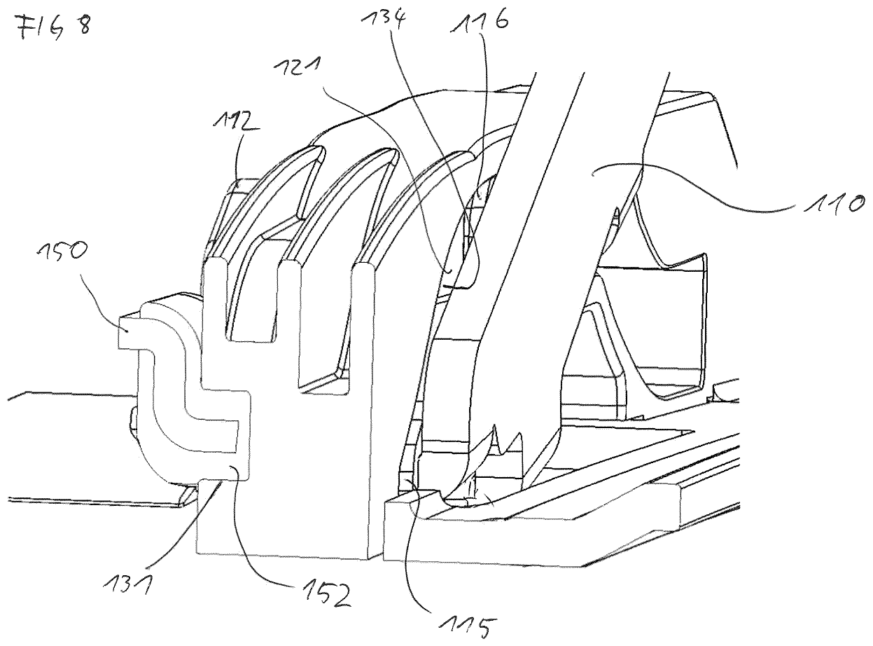

As can be seen in particular from FIGS. 7 to 9, the first portion 123 has a first extent 125. The second portion 124 has a second extent 126. The first extent 125 is smaller than the second extent 126. The extents 125, 126 are the transverse extents of the slotted deployment guide 121 and the sliding path 122 respectively. In the first portion 123, the sliding path 122 is therefore narrower along the transverse direction Y than in the second portion 124. In the second portion 124, the sliding path 122 is wider along the transverse direction Y than in the first portion 123.

The first portion 123 of the slotted deployment guide 121 is formed directly next to the slotted control guide 131. When projected onto an XZ plane, the slotted deployment guide 121 and the slotted control guide 131 at least partially overlap. A partition wall 134 of the carriage 120 is formed between the slotted control guide 131 and the slotted deployment guide 121. Due to the smaller extent 125 in the first portion 123, the carriage can be stably formed with the slotted deployment guide 121 on the side 132 and the slotted control guide 131 on the opposite side 133 without requiring additional installation space along the transverse direction Y.

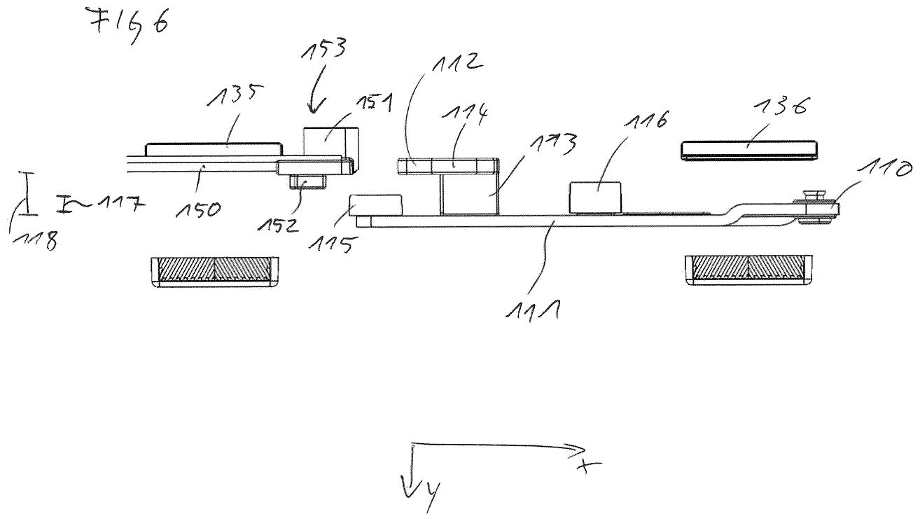

The rear deployment lever 110 has the two lever sliders 115, 116, as can also be seen, for example, in FIG. 6. The two lever sliders 115, 116 each project along the Y-direction over a lever body 111 of the rear deployment lever 110. In operation, the two lever sliders 115, 116 are arranged in the slotted deployment guide 121 and are guided therein. When the carriage 120 moves relative to the deployment lever 110, the deployment lever 110 is thus pivoted.

The first lever slider 115 is arranged at a front end of the lever body 111. The second lever slider 116 is arranged along the longitudinal direction X in the middle of the lever body 111.

In operation, the first lever slider 115 is arranged in the first portion 123 of the slotted deployment guide 121. The second lever slider 116 is arranged for operation in the second portion 124 of the slotted deployment guide 121.

The first lever slider 115 has a first extent 117 along the transverse direction Y. The second lever slider 116 has a second extent 118 along the transverse direction Y. The first extent 117 is smaller than the second extent 118. The second lever slider 116 is wider than the first lever slider 115. The forces occurring during operation are primarily transmitted to the carriage 120 via the second lever slider 116. Lower forces occur on the first lever slider 115. Therefore, the first lever slider 115 can be made narrower than the second lever slider 116.

The first extent 117 of the first lever slider 115 corresponds in particular with the first extent 125 of the slotted deployment guide 121, as can also be seen in particular from FIG. 7. The narrower first lever slider 115 is guided in the first portion 123 of the slotted deployment guide 121 with the narrower sliding path 122.

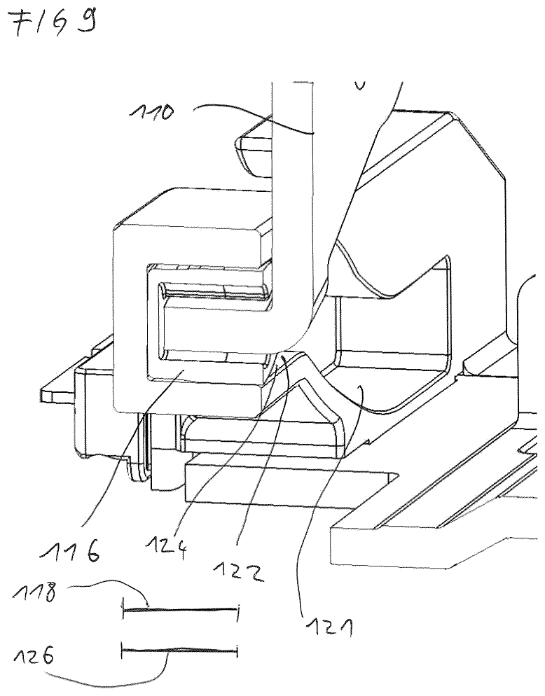

The second extent 118 of the second lever slider 116 corresponds in particular with the second extent 126 of the sliding path 122, as can also be seen in particular from FIG. 9. The wider second lever slider 116 is guided in the wider second portion 124 of the slotted deployment guide 121.

The rear deployment lever 110 has a gripper 112. The gripper has a horizontal part 113, which extends along the transverse direction Y away from the lever body 111. The gripper 112 has a vertical part 114, which extends in an XZ plane. An overmolding 119 made of a plastics material is attached to the vertical part 114.

The lever body 111 and the vertical part 114 run substantially parallel to each other along the longitudinal direction X at a distance from each other along the transverse direction Y. The horizontal part 113 is arranged between the lever body 111 and the vertical part 114.

By means of the gripper 112, the rear deployment lever 110 engages around the carriage 120. For example, the lever body 111 is arranged on the first side 132 of the carriage 120. The horizontal part 130 extends through the carriage 120 to the second side 133 of the carriage 120. The vertical part 114 is arranged on the second side 133 of the carriage 120. In particular, the vertical portion 114 is in contact with the carriage 120 at the second side 133. The overmolding 119 is formed of a material that slides on the carriage 120 with as little friction as possible. In operation, for example, the overmolding 119 is in contact with that of the second side 133 of the carriage 120. Thus, the deployment lever 110 is supported both on the first side 132 of the carriage and on the second side 133. The carriage 120 and the vertical part 114 are designed to allow relative movement with as little friction as possible.

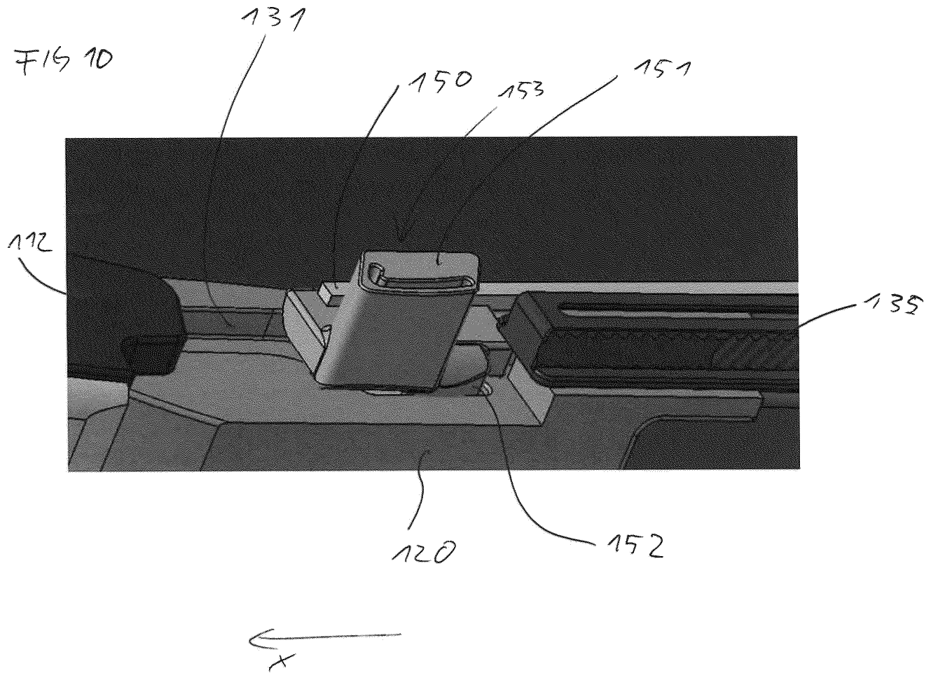

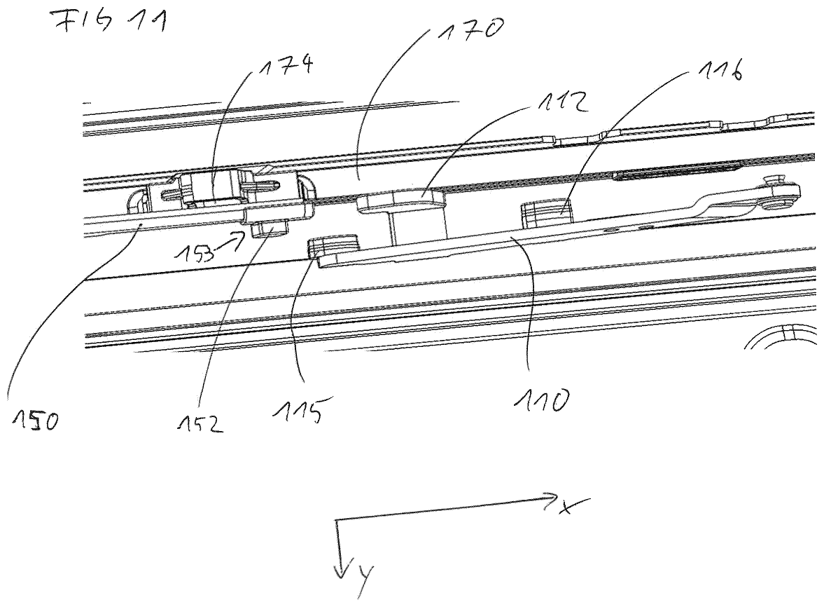

As can be seen from FIGS. 10 and 11, for example, the control rod 150 has a control slider 151 and a protrusion 152 at the first end 153. The control slider 151 protrudes along the transverse direction Y. The protrusion 122 protrudes along the Y direction. However, the control slider 151 and the protrusion 152 protrude in opposite directions along the transverse direction Y.

The protrusion 152 is designed to engage in the slotted control guide 131 of the carriage 120. By means of the engagement of the protrusion 152 in the slotted control guide 131, the first end 153 of the control rod 150 can be moved along the vertical direction Z. Thus, the control rod 150 is movable between a first state and a second state. In the first state, for example, the control rod 150 is locked relative to the guide rail 170 along the longitudinal direction X. In the second state, the control rod 150 is, for example, displaceable relative to the guide rail 170 along the longitudinal direction X, in particular together with the carriage 120. The displacement is caused in particular by the coupling of the protrusion 152 in the slotted control guide 131. Thus, a drive movement of the carriage 120 can be transmitted to the front deployment lever 109 by means of the control rod 150.

The slotted control guide 131 has a substantially rectilinear course. When the protrusion 152 is arranged in the rectilinear region, the carriage 120 is displaceable relative to the control rod 150 along the longitudinal direction X.

The slotted control guide 131 has a region running substantially along the vertical direction Z. When the protrusion 122 is arranged in this region, a movement of the carriage 120 relative to the guide rail 170 along the longitudinal direction X is transmitted to the control rod 150.

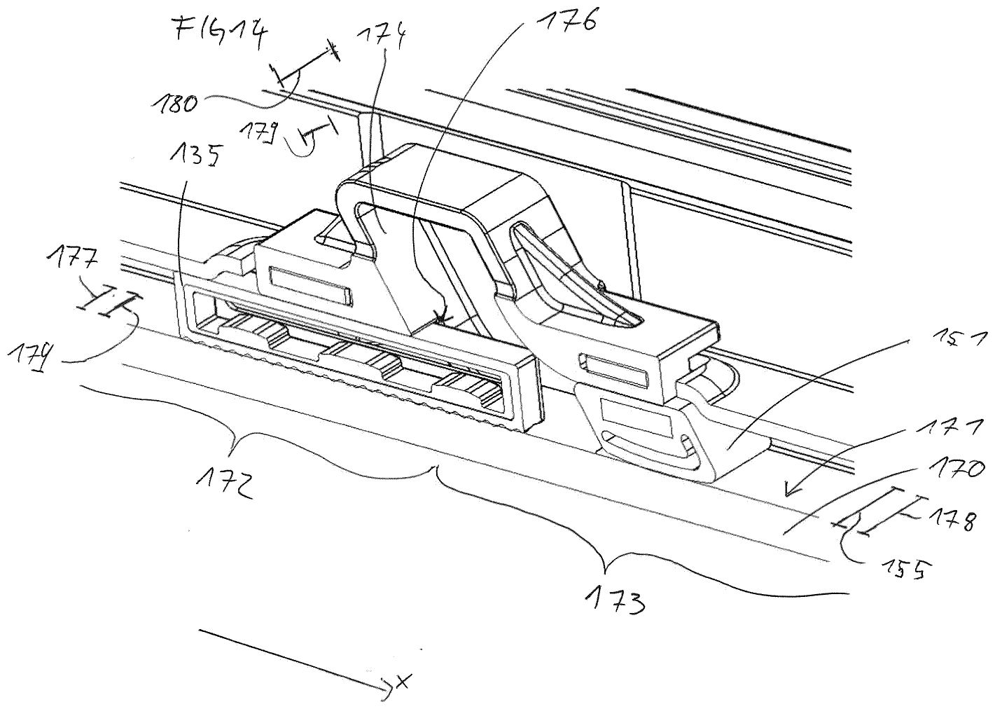

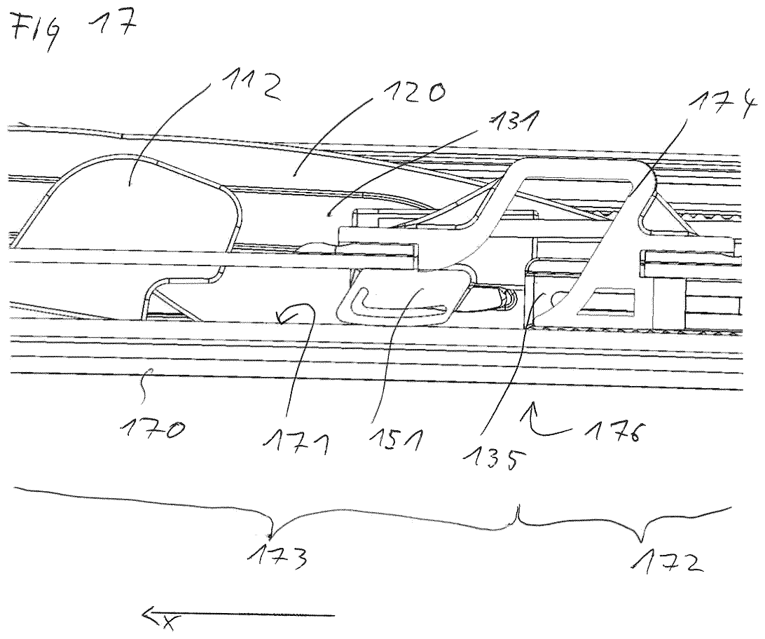

The control slider 151 interacts with a slotted locking guide 174 of the guide rail 170, as can be seen, for example, in FIGS. 14 to 17.

The guide rail 170 has a guide path 171 for the carriage sliders 135, 136. The guide path 171 runs substantially along the longitudinal direction X.

The slotted locking guide 174 runs inclined to the guide path 171 substantially along the vertical direction Z. The slotted locking guide 174 runs at an incline upwards starting from the guide path 171.

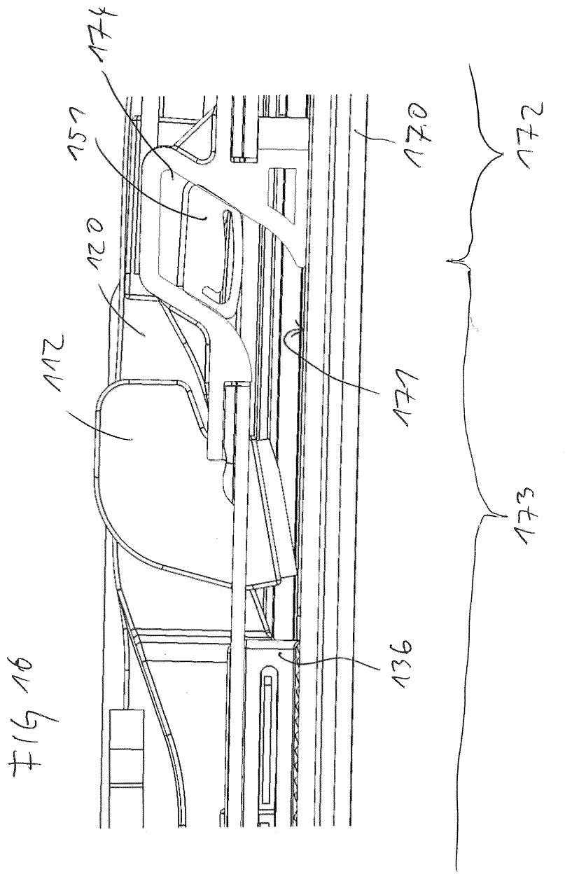

When the control slider 151 is arranged in the slotted locking guide 174, in particular at an upper region of the slotted locking guide 174, the control rod 150 is locked along the longitudinal direction X relative to the guide rail 170 (FIG. 16).

By means of the engagement of the protrusion 152 in the slotted control guide 131, the control slider 151 can be driven to move along the slotted locking guide 174 when the carriage 120 is displaced. Thus, for example, the control slider 141 can be inserted into the slotted locking guide 174 or disengaged therefrom.

When the control slider 151 has been guided out of the slotted locking guide 174 and is arranged on the guide path 171, it is possible to move the control rod 140 along the longitudinal direction X relative to the guide rail 170. In this state, the carriage 120 and the control rod 150 are locked together in such a way that a relative movement along the longitudinal direction X between the carriage 120 and the control rod 150 is blocked.

The guide path 171 has a first portion 172 and a second portion 173. The first portion 172 is arranged along the longitudinal direction X in a front region. The second portion 173 is arranged along the longitudinal direction X in a rear region. Only the carriage slider 135 is guided in the first portion 172. The control slider 151 is not guided in the first portion 172. Both the control slider 151 and the carriage slider 135 are guided in the second portion 173. In the second portion 173, the control slider 151 and the carriage slider 135 run together in the guide path 171.

In the second portion 173, the guide path 171 has a second extent 178, which corresponds in particular to a transverse extent 155 of the control slider 151.

In the first portion 172, the guide path 171 is formed with a first extent 177 according to exemplary embodiments, which is, for example, smaller than the second extent 178. It is also possible that the guide rail 170 in the first portion 172 is just as wide as in the second portion 173, wherein, however, in the first portion 172 only a part of the guide rail 170 is used as the guide path 171 and this part has the first extent 177. In the first portion 172, the guide path 171 is at least wide enough to support the carriage slider 135. In the second portion 173, the guide path 171 is at least so wide that the control slider 151 can be supported in addition to the carriage slider 135. In particular, the first portion 172 is formed in the region of the slotted locking guide 174 in which the transverse extent 177 is limited by the recess 176 and the slotted locking guide 174.

The slotted locking guide 174 has a recess 176 at one end facing the guide path 171. The recess faces the carriage 120 along the transverse direction Y. The recess 176 serves to allow the control slider 151 to be moved back and forth between the first portion 172 and the second portion 173. The slotted locking guide 174 thus does not block the movement of the carriage slider 135. A transverse extent 179 of the recess 176 thus corresponds to a transverse extent 155 of the carriage slider 135 or is only slightly larger. For example, the transverse extent 179 of the recess 176 corresponds to the first extent 177 of the guide path 171 in the first portion 172.

The transverse extent 179 of the recess 176 is in particular smaller than the transverse extent 155 of the control slider 151. Along the transverse direction Y, the recess 176 is bounded by a part of the slotted locking guide 174. This part corresponds, for example, substantially to the difference between the transverse extent 155 of the control slider 151 and the transverse extent of the carriage slider 135. Thus, the control slider 151 cannot be moved back and forth between the two sections 172 and 173 of the guide path 171 due to the slotted locking guide 174.

The slotted locking guide 174 has, for example, a transverse extent 180. The transverse extent 180 of the slotted locking guide 174 is, for example, as large or substantially as large as the transverse extent 155 of the control slider and/or the second extent 178 of the guide path 171. The transverse extent 179 of the recess 176 is smaller than the transverse extent 180 of the slotted locking guide 174.

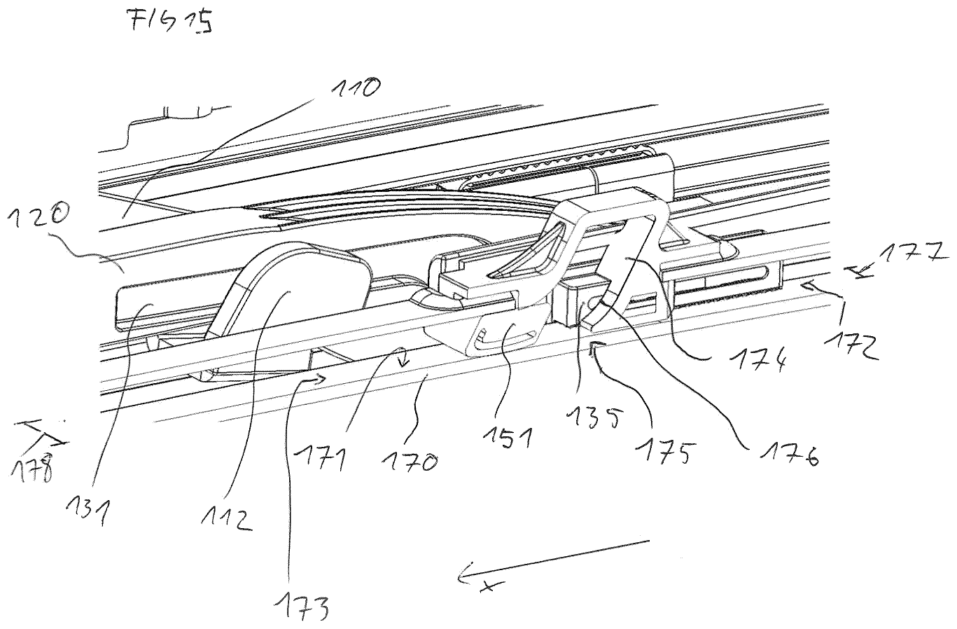

If the control slider 151 is moved forwards along the longitudinal direction X to close the roof opening 102 by means of the cover 103, starting from the position shown in FIG. 15, the control slider 151 encounters the area of the slotted locking guide 174 next to the recess 176 at a transition 175. When the control slider 151 is moved further, the slotted locking guide 174 causes the control slider to be moved away from the guide path 171 and to be pushed into the slotted locking guide 174 along the vertical direction z, as shown, for example, in FIG. 16. Thus, the control rod 150 and thus the front deployment lever 109 is locked along the longitudinal direction X relative to the guide rail 170. The carriage 120 is further displaceable relative to the control rod 150 along the longitudinal direction X relative to the guide rail 170 in order to pivot the rear deployment levers 110.

To open the roof opening 107, the movement sequence is reversed.

The deployment mechanism 108 enables a low installation space requirement both in the Z direction and in the Y direction. Higher natural frequencies can be achieved due to the coupling of the two deployment levers 109, 110. Comparatively low noise emissions are possible during operation. The relative assembly of the individual sliders in relation to each other, in particular the carriage slider 135 and the control slider 151, enables high crash performance. In particular, a robust and reliably operable deployment mechanism 108 is made possible, which can, for example, also move comparatively high cover masses of up to 12 kg or more and can carry and hold them over poor roads even at high vehicle speeds. In particular, the cover 103 can be used reliably and in a stable manner with a higher weight than the conventional cover weight of about 9 kg, for example. Dynamic loads occurring during operation can also be absorbed and transferred to the guide rail despite the comparatively large cover weight.

In particular, it is possible that not all of the components described here are used in the embodiments described here in deployment mechanisms 108 according to exemplary embodiments. In particular, it is possible, for example, to use the carriage 120 with the different extents 125, 126 even without the control rod 150 or with a differently designed control rod. For example, it is possible to use the guide rail 170 with the slotted locking guide 174 and the recess 176 with a differently designed drive carriage which, for example, does not have all the features of the carriage 120 described here.

For example, it is also possible to provide the rear deployment lever 110 with the lever sliders 115, 116 of different widths without the gripper 112. For example, it is also possible to provide the rear deployment lever 110 with the gripper 112 and with lever sliders 115, 116 of the same width.

In the various exemplary embodiments, the deployment mechanism 108 enables, for example, the front deployment lever 109 to be coupled to the rear deployment lever 110 by means of the control rod 150. This enables an improved natural frequency and thus also increased robustness. This makes higher cover weights possible.

The provision of the slotted control guide 131 for the control rod 150 according to embodiments in the carriage 140 requires less installation space overall and, in particular, less installation space is required for the control rod 150.

The slotted control guide 131 is not arranged below the slotted deployment guide 121, in particular along the vertical direction Z, but according to the exemplary embodiment at the same level along the vertical direction Z. This is made possible in particular by the reduction in size of the front lever slider 115. This is also possible because the front lever slider 115 is less heavily loaded during operation. The rear lever slider 116 has a very large slider along the transverse direction Y, as it has to bear most of the load during operation. For this purpose, the extent gate 121 is divided into the two different extents 125, 126 along the transverse direction Y.

By arranging the slotted control guide 131 at the same level along the vertical direction Z as the slotted deployment guide 121, the rear deployment lever 110 can be gripped underneath by means of the gripper 112. The front carriage sliders 135 are arranged along the longitudinal direction X in front of the slotted deployment guide 121 and the slotted control guide 131. This allows the control rod 150 to hook behind the front carriage sliders 135 when the roof is in the open position. This improves the crash performance.

Overall, a very flat mechanical system with high robustness can also be realized for high cover weights. For example, it is possible to integrate lights into the cover or to integrate switchable glazing into the cover. Despite this additional weight, the deployment mechanism 108 ensures reliable operation.

### REFERENCE SIGNS

100 vehicle
101 vehicle roof
102 roof opening
103 cover
104 windshield
105 front edge
106 rear edge
107
108 deployment mechanism
109 front deployment lever
110 rear deployment lever
111 lever body
112 gripper
113 horizontal part
114 vertical part
115, 116 lever sliders
117 first extent
118 second extent
119 overmolding
120 carriage
121 slotted deployment guide
122 sliding path
123 first portion
124 second portion
125 first extent
126 second extent
127 course
128, 129, 130 region
131 slotted control guide
132, 133 sides of the carriage
134 partition wall
135, 136 carriage sliders
137 cable connection
150 control rod
151 control slider
152 protrusion
153 first end
154 second end
155 transverse extent
170 guide rail
171 guide path
172 first portion
173 second portion
174 slotted locking guide
175 transition
176 recess
177 first extent
178 second extent
179 transverse extent of the recess
180 transverse extent of the slotted locking guide
X longitudinal direction
Y transverse direction
Z vertical direction

1. An assembly for moving a cover for a vehicle roof, having:
a guide rail which is elongated along a longitudinal direction,
a carriage which can be moved along the longitudinal direction in the guide rail and having a slotted deployment guide for a deployment lever, wherein the slotted deployment guide has a sliding path which has a first portion and a second portion along the longitudinal direction, wherein the slotted deployment guide has a first extent in the first portion along a transverse direction, which extends transversely to the longitudinal direction, and the slotted deployment guide has a second extent in the second portion along the transverse direction, which is greater than the first extent.

2. The assembly according to claim 1, in which the slotted deployment guide has a course along the longitudinal direction which rises, then runs in a straight line and then falls, wherein the first portion and the second portion adjoin one another in the rectilinear region of the course.

3. The assembly according to claim 1, in which the carriage has a slotted control guide for a control rod, wherein the slotted control guide and the slotted deployment guide are arranged along the transverse direction on opposite sides of the carriage.

4. The assembly according to claim 3, wherein the slotted control guide and the first portion of the slotted deployment guide are arranged next to each other along the transverse direction, and a partition wall of the carriage is arranged between the slotted control guide and the slotted deployment guide .

5. The assembly according to claim 1, in which the carriage has a carriage slider which is guided in the guide rail, wherein the carriage slider and the slotted deployment guide are arranged offset relative to one another along the longitudinal direction.

6. An assembly for moving a cover for a vehicle roof, having:
a guide rail which is elongated along a longitudinal direction and has a guide path for a carriage slider of a carriage and for a control slider of a control rod, wherein the guide path has a first portion and a second portion along the longitudinal direction,
wherein the guide rail has a slotted locking guide for the control rod, wherein the slotted locking guide is arranged at a transition between the first portion and the second portion and has a recess, which is dimensioned such that the carriage slider can be guided through the recess and the control slider can be introduced into the guide path by the slotted locking guide and can be deflected out of the guide path.

7. The assembly according to claim 6, in which the slotted locking guide extends away from the guide path at an angle to the longitudinal direction.

8. The assembly according to claim 6, wherein the first portion is provided to guide the carriage slider, and the second portion is provided to guide the carriage slider and the control slider.

9. The assembly according to claim 6, wherein the guide path has a first extent in the first portion along a transverse direction which runs transversely to the longitudinal direction, and the guide path in the second portion along the transverse direction has a second extent which is greater than the first extent and the first extent corresponds to a transverse extent of the recess.

10. The assembly according to claim 9, in which the slotted locking guide has a transverse extent, at least in sections, which corresponds to the second extent.

11. An assembly for moving a cover for a vehicle roof, having:
a front deployment lever,
a rear deployment lever,
a carriage, wherein the rear deployment lever is in engagement with the carriage,
a control rod for coupling the front deployment lever to the carriage, wherein the control rod has a protrusion for engagement in a slotted control guide of the carriage.

12. The assembly according to claim 11, in which the control rod has a control slider for engagement in a guide rail, wherein the control slider and the protrusion are arranged at a first end of the control rod and are arranged facing away from one another.

13. An assembly for moving a cover for a vehicle roof, having a deployment lever with:
an elongated lever body,
a gripper, which protrudes transversely from the lever body and which is designed to grip around a carriage, so that the lever body and the gripper can be arranged on opposite sides of the carriage.

14. The assembly according to claim 13, in which the deployment lever has a first and a second lever slider, which can each be guided in a slotted deployment guide of the carriage, wherein the first lever slider has a smaller extent along a transverse direction than the second lever slider.

15. (canceled)
